(19) United States
(12) Patent Application Publication
(10) Pub. No.: US 2026/0066672 A1
(43) Pub. Date: Mar. 5, 2026

(54) Charging Circuit And, Charging Method

(71) Applicant: Siemens Schweiz AG, Zürich (CH)

(72) Inventors: Urs Kaestli, Männedorf (CH); Hui Ming Chu, BEIJING (CN); Yi Qing Bi, Beijing (CN); Shao Chen Lin, BSCE, Beijing (CN)

(73) Assignee: Siemens Schweiz AG, Zürich (CH)

(21) Appl. No.: 19/104,574

(22) PCT Filed: Aug. 16, 2023
(86) PCT No.: PCT/IB2023/058230

§ 371 Date: Feb. 18, 2025

(30) Foreign Application Priority Data
Aug. 19, 2022 (CN) 202211003456.4

(51) Int. Cl. H02J 7/34; G08B 5/38; H02J 7/00; H05B 47/10

(52) U.S. Cl. CPC H02J 7/345; G08B 5/38; H02J 7/855; H05B 47/10; H02J 2207/50

(57) ABSTRACT

Various embodiments of the teachings herein include a charging circuit to charge a capacitor of an optical alarm device, connected between the capacitor and a charging bus. The capacitor supplies power to a light-emitting unit. The charging circuit comprising: a voltage detection circuit to detect a first voltage of the charging bus; a boost circuit connected to the charging bus to perform voltage boosting, to charge the capacitor with the boosted voltage; and a controller. The controller controls charging the boost circuit to the capacitor, so the voltage of the capacitor is equal to a second voltage after the light-emitting unit emits light at a target light intensity. The second voltage is equal to the sum of the first voltage and a predetermined difference.

### CROSS-REFERENCE TO RELATED APPLICATIONS

This application is a U.S. National Stage Application of International Application No. PCT/IB2023/058230 filed Aug. 16, 2023, which designates the United States of America, and claims priority to CN application No. 202211003456.4 filed Aug. 19, 2022, the contents of which are hereby incorporated by reference in their entirety.

### TECHNICAL FIELD

The present disclosure relates to fire protection. Various embodiments of the teachings herein include charging circuits, charging methods, electronic devices, and storage media.

### BACKGROUND

An optical alarm device is a kind of fire alarm equipment. When a fire occurs, the optical alarm device can emit flashes of light to alert people to escape and evacuate. It is an important way for hearing-impaired people to obtain fire alarm information. The optical alarm device comprises a capacitor and a light-emitting unit. The light-emitting unit is powered by the capacitor when emitting light, so it is necessary to charge the capacitor upon receiving an alarm instruction, so that the capacitor can provide energy required for the light-emitting unit to emit light. Currently, when the capacitor in the optical alarm device is charged, it is necessary to charge the voltage of the capacitor to a high level, so as to ensure that the capacitor can provide energy required for the light-emitting unit to emit light, and ensure that a charging current of the capacitor in a flashing process of the light-emitting unit is not excessive. However, if the voltage of the capacitor is charged to a high level, the voltage of the capacitor exceeds the requirement of the light-emitting unit, causing energy waste, and it takes a considerable amount of time to charge the voltage of the capacitor to a high level after the alarm instruction is received, resulting in an alarm delay of the optical alarm device.

### SUMMARY

In view of this, various embodiments of the teachings of the present disclosure can reduce energy waste and alarm delay of the optical alarm device. For example, some embodiments include a charging circuit configured to charge a capacitor of an optical alarm device, the charging circuit connected between the capacitor and a charging bus, and the capacitor configured to supply power to a light-emitting unit of the optical alarm device. The charging circuit comprises: a line voltage detection circuit for detecting a line voltage of the charging bus, and obtaining a first voltage; a boost circuit, which is electrically connected to the charging bus and performs voltage boosting, so as to charge the capacitor with the boosted voltage; and a controller, which is electrically connected to the line voltage detection circuit, the boost circuit, the capacitor and the light-emitting unit, and is configured to control the charging of the boost circuit to the capacitor, so that the voltage of the capacitor is equal to a second voltage after the light-emitting unit emits light at a target light intensity, wherein the second voltage is equal to the sum of the first voltage and a predetermined difference.

As another example, some embodiments include a charging method for charging a capacitor of an optical alarm device, in which the capacitor is connected to a charging bus, and the capacitor is configured to supply power to a light-emitting unit of the optical alarm device. The charging method comprises: detecting a line voltage of the charging bus, and obtaining a first voltage; in response to an alarm signal, charging the capacitor by using the line voltage of the charging bus, such that the voltage of the capacitor reaches a second voltage, wherein the second voltage is equal to the sum of the first voltage and a predetermined difference; and charging the capacitor, such that the voltage of the capacitor increases from the second voltage to a third voltage in a charging cycle, wherein the difference between the third voltage and the second voltage enables the light-emitting unit to obtain energy required to emit light at a target light intensity, and the voltage of the capacitor is equal to the second voltage after the light-emitting unit emits light at the target light intensity.

As another example, some embodiments include an electronic device comprising: a processor, a communication interface, a memory and a communication bus, wherein the processor, the memory and the communication interface communicate with each other through the communication bus; and the memory is configured to store at least one executable instruction, the executable instruction causing the processor to perform operations corresponding to the charging method according to the second aspect or any possible implementation of the second aspect.

As another example, some embodiments include a computer-readable storage medium storing thereon a computer instruction that, when executed by a processor, causes the processor to perform operations corresponding to one or more of the charging methods described herein.

As another example, some embodiments include a computer program product: tangibly stored on a computer-readable medium and comprising a computer executable instruction. The computer executable instruction, when executed, causes at least one processor to perform one or more of the charging methods described herein.

### BRIEF DESCRIPTION OF THE DRAWINGS

FIG. 1 is a schematic diagram of an example charging circuit incorporating teachings of the present disclosure;

FIG. 2 is a schematic diagram of an example charging circuit incorporating teachings of the present disclosure;

FIG. 3 is a flowchart of an example charging method incorporating teachings of the present disclosure; and

FIG. 4 is a schematic diagram of an example electronic device incorporating teachings of the present disclosure.

List of reference signs:

| | | |
|---|---|---|
| 100: optical alarm | 400: electronic | 10: charging |
| device | device | circuit |
| 20: capacitor | 30: charging bus | 40: light-emitting |
| | | unit |
| 11: line voltage | 12: boost circuit | 13: controller |
| detection circuit | | |
| 14: first current | 15: second current | 410: program |
| limiting circuit | limiting circuit | |
| 402: processor | 404: communication | 406: memory |
| | interface | |
| 408: communication | 300: charging method | |
| bus | | |
| 301: detect a line | | |
| voltage of a charging | | |
| bus, and obtain a | | |
| first voltage | | |
| 302: in response to an | | |
| alarm signal, charge a | | |
| capacitor such that the | | |
| voltage of the capacitor | | |
| reaches a second voltage | | |
| 303: charge the capacitor | | |
| such that the voltage of | | |
| the capacitor increases | | |
| from the second voltage | | |
| to a third voltage in a | | |
| charging cycle | | |

### DETAILED DESCRIPTION

In various embodiments of the teachings of the present disclosure, after an alarm signal is received, the capacitor is powered by using the line voltage of the charging bus, such that the voltage of the capacitor reaches the second voltage, then the voltage of the capacitor is repeatedly charged from the second voltage to a third voltage during the flashing of the light-emitting unit, and the voltage of the capacitor decreases from the third voltage to the second voltage when the light-emitting unit completes one emission. Since the second voltage is equal to the sum of the first voltage and the predetermined difference, the first voltage changes with the variation of the line voltage of the charging bus, thereby ensuring that the second voltage is greater than the line voltage of the charging bus, without keeping the second voltage always greater than the maximum line voltage of the charging bus. The energy waste and alarm delay of the optical alarm device are reduced while the requirement of flashing of the light-emitting unit is met and there is no large current on the charging bus.

An optical alarm device comprises a capacitor and a light-emitting unit. When the optical alarm device receives an alarm signal, it is necessary to charge the capacitor, and the capacitor supplies power to the light-emitting unit such that the light-emitting unit emits flashes of light at a preset frequency. The light-emitting unit, when emitting light, consumes energy stored in the capacitor, causing a decrease in the voltage of the capacitor, and the capacitor needs to be charged again such that the capacitor can continuously provide the energy required for flashing of the light-emitting unit. If the capacitor is charged to a low level, the voltage of the capacitor decreases to a level smaller than a line voltage of a charging bus after the light-emitting unit emits light, causing a large current on the charging bus, and affecting normal operations of other optical alarm devices, so it is necessary to charge the capacitor to a high level.

Since the line voltage of the charging bus fluctuates, in order to enable the voltage of the capacitor to be greater than the line voltage of the charging bus after the light-emitting unit emits light, the voltage of the capacitor is charged to a level greater than the maximum line voltage of the charging bus. However, the fluctuation range of the line voltage of the charging bus is large, in most cases the line voltage of the charging bus is smaller than the maximum line voltage, and if the voltage of the capacitor is charged to a level greater than the maximum line voltage of the charging bus, the voltage of the capacitor exceeds the requirements of the light-emitting unit, resulting in energy waste. Moreover, it takes a long time to charge the voltage of the capacitor to a level greater than the maximum line voltage of the charging bus after an alarm command is received, resulting in an alarm delay of the optical alarm device.

If the capacitor of the optical alarm device is charged, the line voltage of the charging bus is detected and a first voltage is obtained, the sum of the first voltage and a predetermined difference is calculated as a second voltage, the second voltage is the voltage of the capacitor after the light-emitting unit emits light at a target light intensity, the second voltage can meet the requirements of the light-emitting unit to flash at a set frequency, and the second voltage is greater than the line voltage of the charging bus, avoiding the occurrence of a large current in the charging bus. The second voltage is equal to the sum of the first voltage and the predetermined difference, and the first voltage is determined on the basis of the line voltage of the charging bus, so the first voltage changes with the variation of the line voltage of the charging bus, and the second voltage changes with the variation of the first voltage, ensuring that the second voltage is slightly greater than the line voltage of the charging bus, and the energy waste and alarm delay of the optical alarm device are reduced while the requirement of flashing of the light-emitting unit is met and there is no large current on the charging bus.

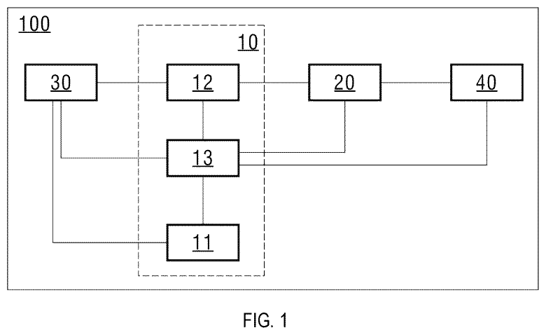

FIG. 1 is a schematic diagram of an example charging circuit incorporating teachings of the present disclosure configured to charge a capacitor of an optical alarm device. As shown in FIG. 1, a charging circuit 10 is connected between a capacitor 20 and a charging bus 30, and the capacitor 20 is configured to supply power to a light-emitting unit 40 of an optical alarm device 100. The charging circuit 10 comprises a line voltage detection circuit 11, a boost circuit 12 and a controller 13.

The line voltage detection circuit 11 can detect a line voltage of the charging bus 30 and obtain a first voltage Vₗᵢₙₑ. The boost circuit 12 is electrically connected to the charging bus 30 and performs voltage boosting on the line voltage of the charging bus 30, so as to charge the capacitor 20 with the boosted voltage. The controller 13 is electrically connected to the line voltage detection circuit 11, the boost circuit 12, the capacitor 20 and the light-emitting unit 40, and the controller 13 can control the charging of the boost circuit 12 to the capacitor 20, so that the voltage of the capacitor 20 is equal to a second voltage V_{holding} after the light-emitting unit 40 emits light at a target light intensity, wherein V_{holding}=Vₗᵢₙₑ+V_{margin}, and V_{margin} is a predetermined difference.

Due to the dynamic variation of the line voltage on the charging bus 30, in the operation of the optical alarm device 100, the line voltage detection circuit 11 can detect the line voltage of the charging bus 30 in real time, so as to obtain the first voltage Vₗᵢₙₑ matching the line voltage of the charging bus 30, and then the controller 13, according to the first voltage Vₗᵢₙₑ, dynamically adjusts the second voltage V_{holding} of the capacitor 20 after the light-emitting unit 40 emits light. It should be understood that the real-time detection of the line voltage of the charging bus 30 by the line voltage detection circuit 11 indicates that the line voltage detection circuit 11 samples the line voltage of the charging bus 30 at a large frequency.

In the operation of the optical alarm device 100, the controller 13 controls the boost circuit 12 to charge the capacitor 20, such that the voltage of the capacitor 20 is charged to a third voltage V_{target}; after the light-emitting unit 40 emits light at a target light intensity, the voltage of the capacitor 20 decreases from the third voltage V_{target} to the second voltage V_{holding}; and before next emission of the light-emitting unit 40, the boost circuit 12 charges the capacitor 20 to the third voltage V_{target} again, enabling the light-emitting unit 40 to flash at a set frequency.

Since the light-emitting unit 40 consumes the same amount of energy each time it emits light at the target light intensity, the difference between the third voltage V_{target} and the second voltage V_{holding} is equal to a fixed value; therefore the third voltage V_{target} is small if the second voltage V_{holding} is small, and the third voltage V_{target} is large if the second voltage V_{holding} is large.

The line voltage detection circuit 11 detects the line voltage of the charging bus 30 and obtains the first voltage Vₗᵢₙₑ, and the first voltage Vₗᵢₙₑ can be an average value of the line voltage of the charging bus 30 over a short period of time, and can also be the maximum value of the line voltage of the charging bus 30 over a short period of time. For example, the line voltage detection circuit 11 samples the line voltage of the charging bus 30 at a frequency of 50 Hz, the first voltage Vₗᵢₙₑ is equal to an average value of the line voltage of the charging bus 30 within the past 1 second, alternatively, the first voltage Vₗᵢₙₑ is equal to the maximum value of the line voltage of the charging bus 30 within the past 1 second.

In some embodiments, the line voltage detection circuit 11 detects the line voltage of the charging bus 30 in real time, and obtains the first voltage Vₗᵢₙₑ according to the line voltage of the charging bus 30, and the controller 13 controls the boost circuit 12 to charge the capacitor 20, such that the voltage of the capacitor 20 is equal to the second voltage V_{holding} after the light-emitting unit 40 emits light at a target light intensity, and V_{holding}=Vₗᵢₙₑ+V_{margin}, wherein V_{margin} represents a predetermined difference. Since the second voltage V_{holding} is equal to the sum of the first voltage Vₗᵢₙₑ and the predetermined difference V_{margin}, the first voltage Vₗᵢₙₑ changes with the variation of the line voltage of the charging bus 30, thereby ensuring that the second voltage V_{holding} is greater than the line voltage of the charging bus 30, without keeping the second voltage V_{holding} always greater than the maximum line voltage of the charging bus 30. The energy waste and alarm delay of the optical alarm device 100 are reduced while the requirement of flashing of the light-emitting unit 40 is met and there is no large current on the charging bus 30.

In some embodiments, the first voltage Vₗᵢₙₑ is equal to the maximum value of the line voltage of the charging bus 30 detected within a predetermined time period. The line voltage detection circuit 11 detects the line voltage of the charging bus 30 in real time, and the maximum value of the line voltage of the charging bus 30 detected by the line voltage detection circuit 11 within a predetermined time period is taken as the first voltage Vₗᵢₙₑ. The predetermined time period can be a time period with the current moment as the endpoint. For example, if the current moment is T1 and T2 is a historical moment, then the predetermined time period is equal to T1-T2. The line voltage detection circuit 11 detects the line voltage of the charging bus 30 at least two times within the predetermined time period, and at least two detection values of the line voltage of the charging bus 30 are obtained.

The line voltage detection circuit 11 continuously detects the line voltage of the charging bus 30, so the predetermined time period is continuously updated as time progresses. When the line voltage of the charging bus 30 fluctuates, if the maximum value of the line voltage of the charging bus 30 detected within the predetermined time period changes, the first voltage Vₗᵢₙₑ changes accordingly.

The maximum value of the line voltage of the charging bus 30 detected by the line voltage detection circuit 11 within the predetermined time period is not necessarily equal to the maximum line voltage of the charging bus 30. For example, if the fluctuation range of the line voltage of the charging bus 30 is 18V to 36V, the maximum line voltage of the charging bus 30 is 36V; and if the range of the line voltage of the charging bus 30 detected by the line voltage detection circuit 11 within a predetermined time period is 24V to 26V, the maximum value of the line voltage of the charging bus 30 detected by the line voltage detection circuit 11 within the predetermined time period is 26V.

In some embodiments, since the line voltage of the charging bus 30 does not undergo significant fluctuations, the maximum value of the line voltage of the charging bus 30 detected within the predetermined time period is taken as the first voltage Vₗᵢₙₑ, and the sum of the first voltage Vₗᵢₙₑ and the predetermined difference V_{margin} is taken as the second voltage V_{holding}, thereby ensuring that the second voltage V_{holding} is greater than the line voltage of the charging bus 30, avoiding generating a large current in the charging bus 30 if the capacitor 20 is charged from the second voltage V_{holding} to the third voltage V_{target}, and ensuring the safety of charging the capacitor 20.

In some embodiments, the predetermined difference V_{margin} is variable.

In some embodiments, since the line voltage of the charging bus 30 is fluctuated, the first voltage Vₗᵢₙₑ is also dynamically changing. As the second voltage V_{holding} is equal to the sum of the first voltage Vₗᵢₙₑ and the predetermined difference V_{margin}, the size of the predetermined difference V_{margin} is adjusted according to the magnitude of the change in the first voltage Vₗᵢₙₑ, thereby ensuring that the second voltage V_{holding} is greater than the line voltage of the charging bus 30, then ensuring that no large current is generated in the charging bus 30 if the capacitor 20 is charged from the second voltage V_{holding} to the third voltage V_{target}, ensuring the safety of charging the capacitor 20, and also ensuring normal operations of a plurality of optical alarm devices 100 connected to the charging bus 30.

In some embodiments, the controller 13 can determine the predetermined difference V_{margin} according to historical data of the first voltage Vₗᵢₙₑ detected by the line voltage detection circuit 11. After the optical alarm devices 100 have been operating for a period of time, the line voltage detection circuit 11 detects a series of historical data of the first voltage Vₗᵢₙₑ, and the historical data of the first voltage Vₗᵢₙₑ can reflect the fluctuations of the line voltage of the charging bus 30. If the line voltage of the charging bus 30 fluctuates little, the predetermined difference V_{margin} Can be appropriately reduced. When the second voltage V_{holding} is ensured to be greater than the line voltage of the charging bus 30, the second voltage V_{holding} and the third voltage V_{target} are reduced. As a result, energy waste must be avoided, making the optical alarm devices 100 more energy-efficient. If the line voltage of the charging bus 30 fluctuates much, the predetermined difference V_{margin} can be appropriately increased, ensuring that the second voltage V_{holding} is greater than the line voltage of the charging bus 30, and avoiding generating a large current in the charging bus 30.

In an example, the controller 13 can determine the predetermined difference V_{margin} according to the historical data of the first voltage Vₗᵢₙₑ within the past six months. In some embodiments, the controller 13 determines the predetermined difference V_{margin} according to the historical data of the first voltage Vₗᵢₙₑ. When the second voltage V_{holding} determined according to the predetermined difference V_{margin} is ensured to be greater than the line voltage of the charging bus 30, the second voltage V_{holding} and the third voltage V_{target} have smaller values. Thus, while the large current is prevented from generating in the charging bus 30, it reduces the energy waste caused by charging the capacitor 20 to a higher voltage, making the optical alarm devices 100 more energy-efficient.

In some embodiments, the predetermined difference V_{margin} is positively correlated with the fluctuation amplitude of the historical data of the first voltage Vₗᵢₙₑ detected by the line voltage detection circuit 11.

If the fluctuation amplitude of the historical data of the first voltage Vₗᵢₙₑ is large, it indicates that the line voltage of the charging bus 30 is unstable, the line voltage of the charging bus 30 may generate significant fluctuations, consequently, the first voltage Vₗᵢₙₑ may also experience significant fluctuations. In order to ensure that the second voltage V_{holding} determined according to the first voltage Vₗᵢₙₑ is greater than the line voltage of the charging bus 30, it is necessary to determine a large predetermined difference V_{margin}. If the fluctuation amplitude of the historical data of the first voltage Vₗᵢₙₑ is small, it indicates that the line voltage of the charging bus 30 is stable, the line voltage of the charging bus 30 may not generate significant fluctuations, consequently, the first voltage Vₗᵢₙₑ may also not experience significant fluctuations, so it only needs a small predetermined difference V_{margin} voltage V_{holding} determined according to the first voltage Vₗᵢₙₑ is greater than the line voltage of the charging bus 30.

The predetermined difference V_{margin} can be determined according to the fluctuation range of the historical data of the first voltage Vₗᵢₙₑ. If the fluctuation amplitude of the line voltage of the charging bus 30 is large, the line voltage of the charging bus 30 at the next moment may undergo significant changes compared with the first voltage Vₗᵢₙₑ at the current moment. In order to ensure that the second voltage V_{holding} determined according to the first voltage Vₗᵢₙₑ at the current moment is greater than the line voltage of the charging bus 30, it needs a large predetermined difference V_{margin}. Even if the line voltage of the charging bus 30 undergoes significant positive fluctuations, it can ensure that the sum of the first voltage Vₗᵢₙₑ and the predetermined difference V_{margin} is greater than the line voltage of the charging bus 30.

In some embodiments, the predetermined difference V_{margin} is positively correlated with the fluctuation amplitude of the historical data of the first voltage Vₗᵢₙₑ. If the fluctuation amplitude of the historical data of the first voltage Vₗᵢₙₑ is large, a larger predetermined difference V_{margin} is determined, and if the fluctuation amplitude of the historical data of the first voltage Vₗᵢₙₑ is small, a smaller predetermined difference V_{margin} is determined. The second voltage V_{holding} is ensured to be greater than the line voltage of the charging bus 30, and the second voltage V_{holding} and the third voltage V_{target} are reduced as much as possible. To avoid generating large currents in the charging bus 30, energy waste caused by charging the capacitor 20 to a higher voltage is reduced, making the optical alarm devices 100 more energy-efficient.

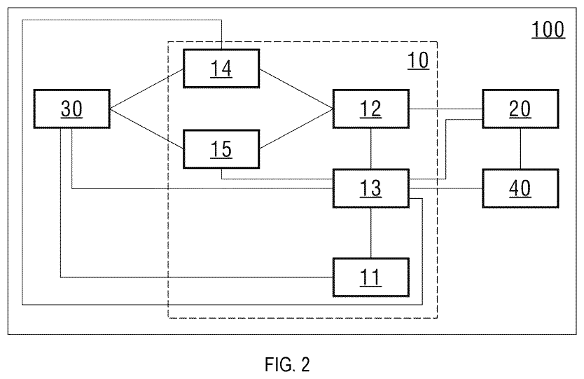

FIG. 2 is a schematic diagram of an charging circuit incorporating teachings of the present disclosure. As shown in FIG. 2, the charging circuit 10 further comprises a first current limiting circuit 14 and a second current limiting circuit 15.

The first current limiting circuit 14 is connected between the charging bus 30 and the boost circuit 12, and the second current limiting circuit 15 is connected between the charging bus 30 and the boost circuit 12. The first current limiting circuit 14 is configured to limit the maximum current transmitted to the boost circuit 12 to a first current value, and the second current limiting circuit 15 is configured to limit the maximum current transmitted to the boost circuit 12 to a second current value, wherein the first current value is smaller than the second current value. The controller 13 can selectively enable at least one of the first current limiting circuit 14 and the second current limiting circuit 15, so as to limit the current transmitted to the boost circuit 12 to the first current value before the capacitor 20 is charged to the second voltage V_{holding}.

If the voltage of the capacitor 20 is smaller than the second voltage V_{holding}, the controller 13 enables the first current limiting circuit 14, and the current transmitted from the charging bus 30 to the boost circuit 12 is limited to a small first current value, so that the boost circuit 12 can start normally. If the capacitor 20 is charged to a voltage greater than the second voltage V_{holding}, the controller 13 enables the second current limiting circuit 15, and the current transmitted from the charging bus 30 to the boost circuit 12 is limited to a large second current value, so as to quickly charge the capacitor 20.

If the voltage of the capacitor 20 is smaller than the second voltage V_{holding}, the controller 13 can enable only the first current limiting circuit 14 or both the first current limiting circuit 14 and the second current limiting circuit 15, and the current transmitted from the charging bus 30 to the boost circuit 12 is limited to a small first current value. If both the first current limiting circuit 14 and the second current limiting circuit 15 are enabled, the first current limiting circuit 14, which has a stronger current limiting effect, plays a decisive role in the current limiting outcome, and the maximum current transmitted to the boost circuit 12 is limited to the first current value. If the capacitor 20 is greater than or equal to the second voltage V_{holding}′ the controller 13 only enables the second current limiting circuit 15, and the current transmitted from the charging bus 30 to the boost circuit 12 is limited to a large second current value.

In some embodiments, the boost circuit 12 has a startup process, and an excessive current may cause damage to the boost circuit 12 in the startup process, so if the voltage of the capacitor 20 is less than the second voltage V_{holding}, the controller 13 enables the first current limiting circuit 14, and the current transferred from the charging bus 30 to the boost circuit 12 is limited to a smaller first current value; and after the voltage of the capacitor 20 is greater than or equal to the second voltage V_{holding}, the controller 13 enables the second current limiting circuit 15, and the current transferred from the charging bus 30 to the boost circuit 12 is limited to a larger second current value. The speed of charging the capacitor 20 is improved while the safety of the boost circuit 12 is ensured.

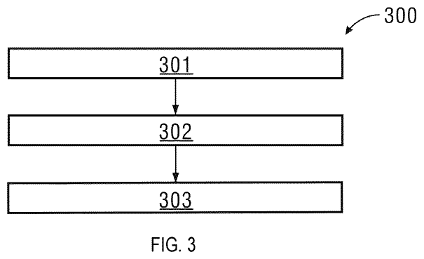

FIG. 3 is a flowchart of an example charging method incorporating teachings of the present disclosure. The charging method is configured to charge a capacitor of an optical alarm device, the capacitor is connected to a charging bus, and the capacitor is configured to supply power to a light-emitting unit of the optical alarm device. As shown in FIG. 3, the charging method 300 comprises: step 301, detecting a line voltage of a charging bus, and obtaining a first voltage;

step 302, in response to an alarm signal, charging a capacitor by using the line voltage of the charging bus, such that the voltage of the capacitor reaches a second voltage, wherein the second voltage is equal to the sum of the first voltage and a predetermined difference; and step 303, charging the capacitor such that the voltage of the capacitor increases from the second voltage to a third voltage in a charging cycle, wherein the difference between the third voltage and the second voltage enables a light-emitting unit to obtain energy required to emit light at a target light intensity, and the voltage of the capacitor is equal to the second voltage after the light-emitting unit emits light at the target light intensity.

In some embodiments, after an alarm signal is received, the capacitor is powered by using the line voltage of the charging bus, such that the voltage of the capacitor reaches the second voltage, then the voltage of the capacitor is repeatedly charged from the second voltage to a third voltage during the flashing of the light-emitting unit, and the voltage of the capacitor decreases from the third voltage to the second voltage when the light-emitting unit completes one emission. Since the second voltage is equal to the sum of the first voltage and the predetermined difference, the first voltage changes with the variation of the line voltage of the charging bus, thereby ensuring that the second voltage is greater than the line voltage of the charging bus, without keeping the second voltage always greater than the maximum line voltage of the charging bus. The energy waste and alarm delay of the optical alarm device are reduced while the requirement of flashing of the light-emitting unit is met and there is no large current on the charging bus.

In some embodiments, the first voltage is equal to the maximum value of the line voltage of the charging bus detected within a predetermined time period.

In some embodiments, since the line voltage of the charging bus does not undergo significant fluctuations, the maximum value of the line voltage of the charging bus detected within the predetermined time period is taken as the first voltage, and the sum of the first voltage and the predetermined difference is taken as the second voltage, thereby ensuring that the second voltage is greater than the line voltage of the charging bus, avoiding generating a large current in the charging bus if the capacitor is charged from the second voltage to the third voltage, and ensuring the safety of charging the capacitor.

In some embodiments, the predetermined difference is variable.

In some embodiments, since the line voltage of the charging bus is fluctuated, the first voltage is also dynamically changing. As the second voltage is equal to the sum of the first voltage and the predetermined difference, the size of the predetermined difference is adjusted according to the magnitude of the change in the first voltage, thereby ensuring that the second voltage is greater than the line voltage of the charging bus, then ensuring that no large current is generated in the charging bus if the capacitor is charged from the second voltage to the third voltage, ensuring the safety of charging the capacitor, and also ensuring normal operations of a plurality of optical alarm devices connected to the charging bus.

In some embodiments, the predetermined difference is determined according to the historical data of the detected first voltage. In some embodiments, the controller determines the predetermined difference according to the historical data of the first voltage. When the second voltage determined according to the predetermined difference is ensured to be greater than the line voltage of the charging bus, the second voltage and the third voltage have smaller values. Thus, while the large current is prevented from generating in the charging bus, it reduces the energy waste caused by charging the capacitor to a higher voltage, making the optical alarm devices more energy-efficient.

In some embodiments, the predetermined difference is positively correlated with the fluctuation amplitude of the historical data of the detected first voltage.

In some embodiments, the predetermined difference is positively correlated with the fluctuation amplitude of the historical data of the first voltage. If the fluctuation amplitude of the historical data of the first voltage is large, a larger predetermined difference is determined, and if the fluctuation amplitude of the historical data of the first voltage is small, a smaller predetermined difference is determined. The second voltage is ensured to be greater than the line voltage of the charging bus, and the second voltage and the third voltage are reduced as much as possible. To avoid generating large currents in the charging bus, energy waste caused by charging the capacitor to a higher voltage is reduced, making the optical alarm devices more energy-efficient.

In some embodiments, before the capacitor is charged to the second voltage, a charging current of the capacitor is limited to the first current value. The charging current of the capacitor is limited to a second current value after the capacitor is charged to the second voltage, wherein the second current value is greater than the first current value.

In some embodiments, the boost circuit has a startup process, and an excessive current may cause damage to the boost circuit in the startup process, so if the voltage of the capacitor is less than the second voltage, the controller enables the first current limiting circuit, and the current transferred from the charging bus to the boost circuit is limited to a smaller first current value; and after the voltage of the capacitor is greater than or equal to the second voltage, the controller enables the second current limiting circuit, and the current transferred from the charging bus to the boost circuit is limited to a larger second current value. The speed of charging the capacitor is improved while the safety of the boost circuit is ensured.

It should be noted that the above charging method and the previous embodiments of the charging circuit are based on the same concept. For the specific details and beneficial effects, reference can be made to the description of the previous embodiments of the charging circuit, which will not be repeated here.

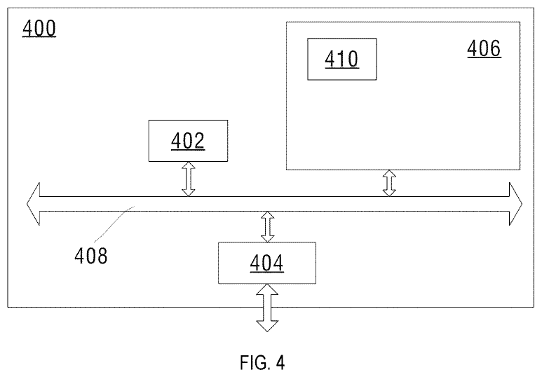

FIG. 4 is a schematic diagram of an example electronic device incorporating teachings of the present disclosure. The specific embodiments of this application do not limit the specific implementation of the electronic device. With reference to FIG. 4, the electronic device 400 comprises: a processor 402, a communication interface 404, a memory 406, and a communication bus 408. The processor 402, the communication interface 404, and the memory 406 communicate with each other through the communication bus 408. The communication interface 404 is configured to communicate with other electronic devices or servers.

The processor 402 is configured to execute a program 410, which specifically can execute the relevant steps in any of the previous embodiments of the charging method. Specifically, the program 410 may comprise program code, which comprises computer operation instructions.

The processor 402 may be a central processing unit (CPU), or an application specific integrated circuit (ASIC), or one or more integrated circuits configured to implement the embodiments of the present application. One or more processors comprised in a smart device may be of the same type, for example, one or more CPUs; or of different types, for example, one or more CPUs and one or more ASICS.

The memory 406 is configured to store a program 410. The memory 406 may comprise a high-speed RAM, and may further comprise a non-volatile memory, for example, at least one disk memory.

The program 410 can be specifically configured to enable the processor 402 to execute any of the previous embodiments of the charging methods.

For the specific implementation of each step in the program 410, reference can be made to the corresponding descriptions in the respective steps and units according to any of the previous embodiments of the charging method, which will not be repeated here. Those skilled in the art can clearly understand that, for the convenience and simplicity of the description, the corresponding process description in the method embodiments above may be referred to for the specific working process of the devices and modules described above, which will not be detailed here.

With the electronic device, after an alarm signal is received, the capacitor is powered by using the line voltage of the charging bus, such that the voltage of the capacitor reaches the second voltage, then the voltage of the capacitor is repeatedly charged from the second voltage to a third voltage during the flashing of the light-emitting unit, and the voltage of the capacitor decreases from the third voltage to the second voltage when the light-emitting unit completes one emission. Since the second voltage is equal to the sum of the first voltage and the predetermined difference, the first voltage changes with the variation of the line voltage of the charging bus, thereby ensuring that the second voltage is greater than the line voltage of the charging bus, without keeping the second voltage always greater than the maximum line voltage of the charging bus. The energy waste and alarm delay of the optical alarm device are reduced while the requirement of flashing of the light-emitting unit is met and there is no large current on the charging bus.

### Computer Storage Medium

Some examples include a computer-readable storage medium, which has stored thereon an instruction that causes a machine to perform one or more of the charging methods described herein. Specifically, a system or apparatus equipped with a storage medium may be provided; software program code realizing functions of any one of the embodiments above is stored on the storage medium, and a computer (or CPU or MPU) of the system or apparatus is caused to read and execute the program code stored in the storage medium. In this case, the program code read from the storage medium can implement the functions of any of the embodiments described above, and therefore the program code and the storage medium storing the program code constitute part of the present application.

The embodiments of storage media used for providing the program code include floppy disks, hard disks, magneto-optical disks, optical disks (such as CD-ROM, CD-R, CD-RW, DVD-ROM, DVD-RAM, DVD-RW, DVD+RW), magnetic tapes, non-volatile memory cards and ROM. Optionally, the program code may be downloaded from a server computer via a communication network. An operating system operating on a computer can be made to complete part or all of actual operations, not only through execution of the program code read by a computer, but also by means of instructions based on the program code, so as to realize functions of any one of the embodiments above.

The program code read from the storage medium is written into a memory provided on an expansion board inserted into a computer or written into a memory provided in an expansion module connected to a computer, and then based on the instruction of the program code, the CPU, etc., installed on the expansion board or the expansion module performs part or all of the actual operations, thereby implementing the functions of any of the embodiments described above.

Some examples include a computer program product, which is stored in a tangible computer-readable medium and includes computer executable instructions that, when executed, cause at least one processor to perform one or more of the charging methods described herein. The solutions in this embodiment have the corresponding technical effects in the method embodiments described above, which will not be detailed here.

Not all of the steps and modules in the flows and system structure diagrams above are necessary and certain steps or modules may be omitted according to actual requirements. The sequence in which the steps are executed is not fixed but may be adjusted as needed. The system structures described in the embodiments above may be physical structures, and may also be logical structures, i.e., some modules might be realized by the same physical entity, or some modules might be realized by a plurality of physical entities or realized jointly by certain components in a plurality of independent devices.

With the charging methods for a capacitor, the apparatus, the electronic devices, the computer-readable storage media, and the computer program products, the introduction is relatively brief, and the relevant content and beneficial effects can be understood by referring to the various embodiments of the charging method for a capacitor described previously, which will not be repeated here.

A hardware module may be realized in a mechanical or an electrical manner. For example, a hardware module may comprise permanently dedicated circuitry or logic (for example, a dedicated processor, an FPGA, or an ASIC) to perform the corresponding operations. The hardware module may further comprise programmable logic or circuitry (for example, a general-purpose processor or other programmable processors), which may be temporarily configured by software to complete the corresponding operations. Particular implementations (mechanical, or dedicated permanent circuitry, or temporarily set circuitry) may be determined based on considerations of cost and time.

The present application has been demonstrated and described in detail in conjunction with the drawings and preferred embodiments, but the present application is not limited to these disclosed embodiments. Those skilled in the art can understand that more embodiments of the present application can be obtained by combining the code review means in different embodiments described above based on the various embodiments above, and these embodiments also fall within the scope of the present application.

What is claimed is:

1. A charging circuit to charge a capacitor of an optical alarm device, the charging circuit connected between the capacitor and a charging bus, the capacitor configured to supply power to a light-emitting unit of the optical alarm device, charging circuit comprising:
a line voltage detection circuit to detect a line voltage of the charging bus and obtaining a first voltage;
a boost circuit electrically connected to the charging bus to performs voltage boosting, so as to charge the capacitor with the boosted voltage; and
a controller electrically connected to the line voltage detection circuit, the boost circuit, the capacitor, and the light-emitting unit;
wherein the controller controls charging the boost circuit to the capacitor, so the voltage of the capacitor is equal to a second voltage after the light-emitting unit emits light at a target light intensity; and
the second voltage is equal to the sum of the first voltage and a predetermined difference.

2. The charging circuit according to claim 1, wherein the first voltage is equal to a maximum value of the line voltage detected on the charging bus within a predetermined time period.

3. The charging circuit according to claim 1, wherein the according to claim predetermined difference is variable.

4. The charging circuit according to claim 3, wherein the controller determines the predetermined difference based at least in part on historical data of the first voltage detected by the line voltage detection circuit.

5. The charging circuit according to claim 4, wherein the predetermined difference is positively correlated with a fluctuation amplitude of the historical data of the first voltage detected by the line voltage detection circuit.

6. The charging circuit according to claim 1, further comprising:
a first current limiting circuit connected between the charging bus and the boost circuit to limit the maximum current to a first current value; and
a second current limiting circuit connected between the charging bus and the boost circuit to limit the maximum current to a second current value, wherein the first current value is smaller than the second current value;
wherein the controller selectively enables at least one of the first current limiting circuit and the second current limiting circuit to limit the maximum current to the first current value before the capacitor is charged to the second voltage.

7. A charging method for charging a capacitor of an optical alarm device, the capacitor connected to a charging bus and configured to supply power to a light-emitting unit of the optical alarm device, the method comprising:
detecting a line voltage of the charging bus and obtaining a first voltage;
in response to an alarm signal, charging the capacitor by using the line voltage of the charging bus so the voltage of the capacitor reaches a second voltage, equal to a sum of the first voltage and a predetermined difference; and
charging the capacitor so the voltage of the capacitor increases from the second voltage to a third voltage in a charging cycle, wherein the difference between the third voltage and the second voltage enables the light-emitting unit to obtain energy required to emit light at a target light intensity;
wherein the voltage of the capacitor is equal to the second voltage after the light-emitting unit emits light at the target light intensity.

8. The method according to claim 7, wherein the first voltage is equal to the maximum value of the line voltage of the charging bus detected within a predetermined time period.

9. The method according to claim 7, wherein the predetermined difference is variable.

10. The method according to claim 9, wherein the predetermined difference is determined according to historical data of the detected first voltage.

11. The method according to claim 10, wherein the predetermined difference is positively correlated with a fluctuation amplitude of the historical data of the detected first voltage.

12. The method according to claim 7, wherein the method further comprises:
limiting a charging current of the capacitor to a first current value before the capacitor is charged to the second voltage; and
limiting the charging current of the capacitor to a second current value after the capacitor is charged to the second voltage;
wherein the second current value is greater than the first current value.

13. An electronic device comprising:
a processor;
a communication interface;
a memory; and
a communication bus;
wherein the processor, the communication interface, and the memory communicate with each other through the communication bus; and
the memory stores executable instructions, the executable instruction causing the processor to:
detect a line voltage of a charging bus and obtain a first voltage;
in response to an alarm signal, charge a capacitor using the line voltage of the charging bus so the voltage of the capacitor reaches a second voltage equal to a sum of the first voltage and a predetermined difference; and
charging the capacitor so the voltage of the capacitor increases from the second voltage to a third voltage in a charging cycle, wherein the difference between the third voltage and the second voltage enables a light-emitting unit to obtain energy required to emit light at a target light intensity;
wherein the voltage of the capacitor is equal to the second voltage after the light-emitting unit emits light at the target light intensity.

14. (canceled)
